(19) United States
(12) Patent Application Publication
(10) Pub. No.: US 2024/0344745 A1
(43) Pub. Date: Oct. 17, 2024

(54) ADSORBER AND METHOD FOR MANUFACTURING AN ADSORBER

(71) Applicant: UNIVERSITE DE LORRAINE, Nancy (FR)

(72) Inventors: Allaoua SOUDANI, Vandoeuvre-les-Nancy (FR); Riad BENELMIR, Houdemont (FR)

(21) Appl. No.: 18/293,654

(22) PCT Filed: Aug. 1, 2022
(86) PCT No.: PCT/EP2022/071550

§ 371 Date: Feb. 22, 2024

(30) Foreign Application Priority Data
Aug. 3, 2021 (FR) 2108422

(51) Int. Cl. F25B 37/00; B01J 20/10; B01J 20/26; B01J 20/28

(52) U.S. Cl. CPC F25B 37/00; B01J 20/103; B01J 20/26; B01J 20/28011

(57) ABSTRACT

A method for manufacturing a porous adsorbent coating, including the steps of obtaining a homogeneous mixture including water, mesoporous particles in which the grains have a diameter of less than 800 μm and a reinforcement, covering all or part of a component to be coated with a layer of homogeneous mixture, and compressing the layer of mixture onto the component to be coated under a pressure of more than 10 bar is disclosed.

### TECHNICAL FIELD

The present invention is concerned with the technical field of heat exchangers.

The invention relates to an adsorber, in particular in the form of a coating, thus to the method for manufacturing such an adsorber.

The invention relates to a heat exchanger comprising an adsorbent, that is an adsorber, for an adsorption machine and, in particular, for an adsorption refrigeration machine.

### STATE OF PRIOR ART

The manufacture of adsorbers by adhering an adsorbent to a metal piece is known in the state of prior art. This adhesive layer reduces heat transfer between the metal piece and the adsorbent. Furthermore, the adhesive tends to diffuse into the adsorbent, thus reducing its thermal conductivity and adsorption capacity.

In the case of adsorption machines, such an adsorber therefore has the effect of reducing performance of the adsorption machine.

One purpose of the invention is especially:
to provide an adsorber with improved heat transfer between the piece on which the adsorbent rests and the adsorbent, and/or
to provide a more compact adsorbent and/or adsorber than those of the state of the art, and/or
to provide an adsorbent and/or an adsorber having a smaller volume than the adsorbents of the state of the art and performance, in terms of adsorption, equivalent to that of the adsorbents of the state of the art, and/or
to provide an adsorber whose thermal conductivity is equivalent to or greater than that of the adsorbers of the state of the art, and/or
to provide a method for manufacturing an adsorbent coating which is faster than the methods of the state of the art.

### DISCLOSURE OF THE INVENTION

To this end, a method for manufacturing a porous adsorbent coating is provided, said method comprising the steps of:
obtaining a homogeneous mixture comprising water, mesoporous particles whose grains have a diameter of less than 800 μm and a reinforcement,
covering all or part of a piece to be coated with a layer of homogeneous mixture,
compressing the layer of mixture onto the piece to be coated under a pressure greater than 10 bar.

The homogeneous mixture may be liquid, viscous or pasty.

Preferably, the pressure exerted to compress the homogeneous layer is greater than or equal to 20 bar, even more preferably greater than 30 bar, even more preferably greater than 40 bar, even more preferably greater than 50 bar, even more preferably greater than 60 bar, even more preferably greater than 70 bar, especially preferably greater than 80 bar and most preferably greater 90 bar.

Preferably, the mesoporous particle grains have a diameter of less than 500 μm, further preferably less than 250 μm and more preferably less than 100 μm.

Preferably, the method according to the invention is a method for manufacturing a porous adsorbent coating for a heat exchanger. By heat exchanger, it may be meant an adsorber-exchanger or an adsorbent heat exchanger. Preferably, the method according to the invention is a method for manufacturing a heat exchanger of an adsorption machine.

The water may comprise one or more additives and/or one or more salts.

The water may be substituted with another solvent. The solvent may be an organic or inorganic solvent.

The method may include a step of drying the piece. Drying can be carried out at ambient temperature or under heating. Drying can be carried out in air, that is under atmospheric conditions, or under a controlled atmosphere. Drying can be carried out during use, for example during the first use or uses, of the coated piece or prior to use of the coated piece.

Preferably, the mixture, preferably the homogeneous mixture, does not include any adhesive.

By mesoporous particles, it may be meant a powder comprising or consisting of grains or particles.

The mesoporous particles may comprise, preferably consist of, mesoporous alumina, mesoporous carbon, mesoporous oxides, in particular metallic oxides, or zeolites.

The reinforcement can be a linear polymer.

The reinforcement can be a branched polymer.

Preferably, the reinforcement is a branched linear polymer.

Preferably, the reinforcement is cellulose.

Preferably, the mesoporous particles comprise or are silica gel.

The mixture, preferably the homogeneous mixture, may comprise:
between 30 and 98%, preferably between 50 and 95%, by mass, of water,
between 3 and 60%, preferably between 25 and 35%, by mass, of mesoporous particles,
between 2 and 40%, preferably between 8 and 15%, by mass, of a reinforcement.

Preferably, the mass percentage of water is greater than 50%, by mass, further preferably greater than 60%, more preferably greater than 65% and/or less than 98%, by mass, and more preferably less than 95%.

Preferably, the mass percentage of reinforcement is greater than 2% by mass, further preferably greater than 5%, more preferably greater than 6% and even more preferably greater than 8% and/or less than 40% by mass, preferably less than 25% and more preferably less than 15%.

Preferably, the mass percentage of mesoporous particles is greater than 3% by mass, preferably greater than 10%, more preferably greater than 25% and/or less than 60% by mass.

Preferably, the sum of the upper bounds of the ranges of mass percentage of mesoporous particles and of reinforcement in the mixture is equal to the lower bound of the range of the mass percentage of water in the mixture. Preferably, the sum of the lower bounds of the ranges of the mass percentage of mesoporous particles and of reinforcement in the mixture is equal to the upper bound of the range of the mass percentage of water in the mixture.

Preferably, the piece to be coated comprises two faces or sides connected through a slice or an edge and wherein the step of covering all or part of the piece to be coated consists in coating the slice and all or part of each of the two faces of the piece.

The step of covering all or part of the piece to be coated may be a coating step.

The slice or edge may be a curved surface.

The method may comprise prior to or concomitantly to the step of compressing the layer of mixture onto the piece to be coated, a step of arranging one or more holding elements, for holding, or participating in holding, the coating on the piece, after the coating has been manufactured.

The method may comprise, prior to, concomitantly to or subsequent to the step of covering all or part of the piece to be coated, preferably the coating step, a step of arranging the piece to be coated in a mould, preferably a press mould.

The method may comprise, subsequent to the step of compressing the layer of mixture onto the piece to be coated and prior to, concomitantly to or subsequent to the drying step, a step of mould releasing the piece to be coated.

The step of covering all or part of the piece to be coated can be carried out by applying, depositing, casting, injecting, spraying or vaporising the homogeneous mixture onto the piece to be coated.

Porous adsorbent coating obtainable by the method according to the invention.

Preferably, the porous adsorbent coating is directly obtained by the method according to the invention.

According to the invention, there is also provided a porous adsorbent coating comprising:
between 50 and 80%, by mass, of mesoporous particles whose grains have a diameter of less than 800 μm,
between 3 and 50%, by mass, of a reinforcement,
between 5 and 40%, by mass, of adsorbed water.

Preferably, the mass percentage of water is greater than 5%, by mass, preferably greater than 7% and/or less than 40%, by mass, preferably less than 25%, even more preferably less than 10%.

Preferably, the percentage by weight of reinforcement is greater than 3%, by weight, preferably greater 10% and/or less than 50%, by weight, preferably less than 20%.

Preferably, the mass percentage of mesoporous particles is greater than 50%, by mass, preferably greater than 60% and/or less than 80%, by mass, preferably less than 70%. 15 Preferably, the sum of the upper bounds of the ranges of the mass percentage of mesoporous particles and reinforcement in the mixture is equal to the lower bound of the range of the mass percentage of water in the mixture.

Preferably, the sum of the lower bounds of the ranges of the mass percentage of mesoporous particles and reinforcement in the coating is equal to the upper bound of the range of the mass percentage of water in the coating. It should be noted that, by nature, the amount of water adsorbed in the coating may vary. The amount of water adsorbed in the coating can vary between 5 and 40%, by mass, when the coating, preferably covering a piece, is in use.

The porous adsorbent coating may be, in particular of the state of the art, called or a referred to as an adsorbent.

Preferably, the porous coating is that of an adsorber. Preferably, the adsorber comprises, preferably is formed by, the piece to be coated and the coating or adsorbent.

In the present application, the term coating or adsorbent coating used alone refers to the porous adsorbent coating according to the invention.

Preferably, the adsorbent coating does not comprise an adhesive.

Preferably, the mesoporous particles comprise or are silica gel.

Preferably, the total porosity of the adsorbent coating is between 1 nm and 100 μm. Preferably, the total porosity of the coating is greater than 1 nm, even more preferably greater than 100 nm, preferably greater than 1 μm and even more preferably greater than 4 μm and/or less than 100 μm, preferably less than 50 μm.

Preferably, the coating has a thickness of between 0.1 mm and 20 mm. Preferably, the thickness of the coating is greater than 0.1 mm, preferably greater than 0.5 mm and/or less than 20 mm, preferably less than 15 mm.

The thickness of the coating can be defined as the dimension of the coating along the direction extending perpendicularly from an outer surface of the piece to be coated outwardly of the piece to be coated.

According to the invention, a use of the porous ad-sorbent coating according to the invention in a heat exchanger, preferably in a heat exchanger of an adsorption machine is also provided.

According to the invention, a heat exchanger comprising the coating according to the invention is also provided.

The heat exchanger may, in particular of the state of the art, be called or referred to as an adsorber-exchanger or an adsorbent heat exchanger. Hence, in the present application, by heat exchanger, it may be understood an adsorber-exchanger or an adsorbent heat exchanger.

Preferably, at least one part of a surface, preferably an outer surface, of the heat exchanger is formed by the coating. Preferably, only one part of the surface of the heat exchanger is formed by the heat exchanger.

In the present application, the term exchanger used alone refers to the heat exchanger or thermal exchanger according to the invention.

The heat exchanger may be a heat exchanger of an adsorption machine.

The heat exchanger may comprise at least one piece at least partly coated or covered or lined with the coating; the at least one piece has a thermal conductivity greater than 1 W/m/K.

Preferably, the at least one piece coated with the coating forms an adsorber.

Preferably, the at least one coated piece is a metal. Preferably, the at least one coated piece can be copper.

Preferably, the coating directly rests on the at least one piece.

Preferably, the coating is in direct contact with a surface, preferably the outer surface, of the at least one piece.

Preferably, the heat exchanger does not comprise any adhesive between the coating and the surface, preferably the outer surface, of the at least one piece. By adhesive it may be meant any compound or layer, in particular located between the coating on the at least one piece, having the effect of holding the coating on the at least one piece.

Preferably, the coating adheres to the at least one piece.

The at least one piece may comprise two faces and an slice connecting said two faces. The coating may form a continuous layer and may line said slice and at least one part of each of said two faces.

The two faces may be substantially planar surfaces connected through the slice. The slice may form an annular part of the at least one piece.

Preferably, the two planar surfaces are two surfaces substantially parallel to each other.

Preferably, the two planar surfaces form two opposite sides of the at least one piece.

Preferably, the two planar surfaces are two substantially circular surfaces.

Preferably, the at least one piece is a disc.

The heat exchanger may comprise a heat pipe to which the at least one piece at least partly coated with the coating is mounted.

Preferably, the at least one piece comprises an opening. Preferably, the heat pipe has a tubular shape and passes through the opening of the at least one piece.

The opening may be located in the centre of the at least one piece.

The heat exchanger may comprise one or more holding elements arranged to hold, or assist in holding, the coating on the at least one piece after the coating has been manufactured.

The holding element(s) may comprise at least one surface in contact, preferably in direct contact, with the coating. The holding element(s) may comprise a surface in contact, preferably direct contact, with the at least one piece.

According to the invention, a use of the heat exchanger according to the invention in an adsorption machine is also provided.

According to the invention, an adsorption machine comprising at least one heat exchanger according to the invention is also provided.

The method according to the invention is particularly adapted, further preferably specially designed, to implement the coating and/or heat exchanger according to the invention. Thus, any characteristic of the method according to the invention can be integrated into the coating and/or heat exchanger according to the invention and vice versa.

### DESCRIPTION OF THE FIGURES

Further advantages and features of the invention will become apparent upon reading the detailed description of implementations and embodiments, which are by no means limiting, and the following appended drawings:

FIG. 1 is an image showing three adsorbers,

FIG. 2 is an image illustrating a heat exchanger comprising a heat pipe to which adsorbers are mounted,

FIG. 3 is an image of a piece to be coated comprising a disc to which a ring is attached,

FIG. 4 is an image of a copper disc,

FIG. 5 is an image of a brass ring,

FIG. 6 is an image of a press mould,

FIG. 7 is an image of a press mould in the cavity of which the copper disc rests.

### DESCRIPTION OF THE EMBODIMENTS

As the embodiments described below are by no means limiting, it will be possible especially to consider alternatives to the invention comprising only a selection of described characteristics, isolated from the other described characteristics (even if this selection is isolated within a sentence comprising these other characteristics), if this selection of characteristics is sufficient to confer a technical advantage or to differentiate the invention from prior art. This selection comprises at least one characteristic, preferably functional without structural details, or with only part of the structural details if this part alone is sufficient to confer a technical advantage or to differentiate the invention from prior art.

Adsorption is the phenomenon reflecting the attachment of a gas (adsorbate) to the surface of a solid (adsorbent). According to the invention, the adsorbent is particularly adapted for physisorption, which is a totally reversible reaction. Molecules attached to the surface (adsorbed) can be removed (desorbed) by heating the surface of the adsorbent or by lowering pressure of the adsorbate. In the case of chemisorption, the conditions are much more difficult and sometimes the reaction is irreversible. Adsorption of a gas is exothermic, with an isosteric heat of a few dozen KJ/mol. For chemisorption, the isosteric heat of sorption is several hundred KJ/mol.

An adsorption machine is comprised of four elements (evaporator, adsorber, condenser, desorber) and an expansion system. The machine is driven by virtue of two hydraulic circuits: a heating circuit, which raises and maintains temperature of a first bed operating in desorption mode, and a cooling circuit, which lowers and maintains temperature of a second bed operating in adsorption mode and cools the machine's condenser. The adsorbate circuit is automatically controlled by two valves ensuring circulation of the adsorbate from the evaporator to the adsorber (cold production) and two valves ensuring circulation from the desorber to the condenser (heat removal).

As regards adsorption machines, and in particular adsorption refrigeration machines, the adsorber and its manufacture play a key role. Indeed, the adsorber can be considered the engine of adsorption refrigeration machines. Optimising the pore size and thermal conductivity of the adsorbent improves the efficiency of adsorption machines. A larger surface area increases adsorption capacity. A good match between the pore diameter and the adsorbate improves adsorption rate. Better thermal conduction promotes heat transfer in the material, which directly leads to an increase in the power of the adsorption refrigeration machine.

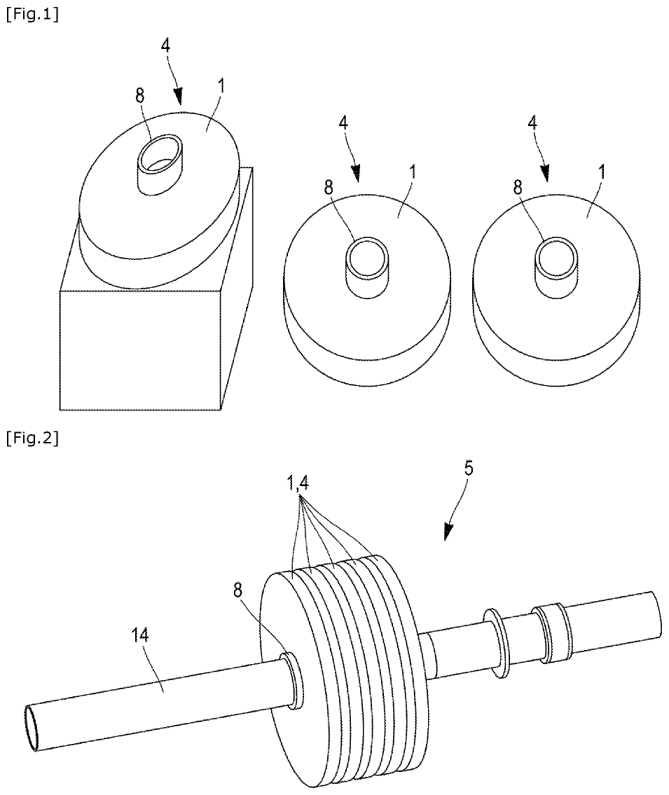

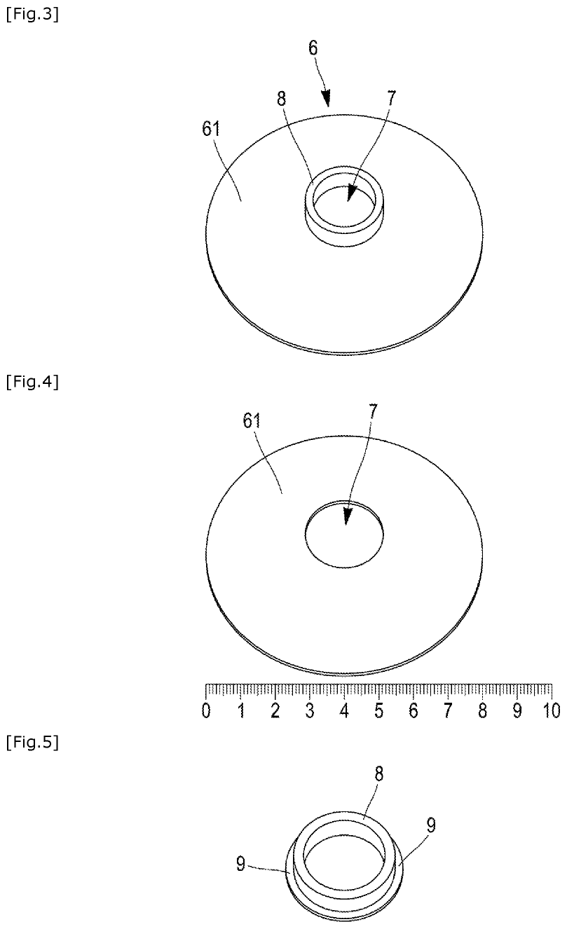

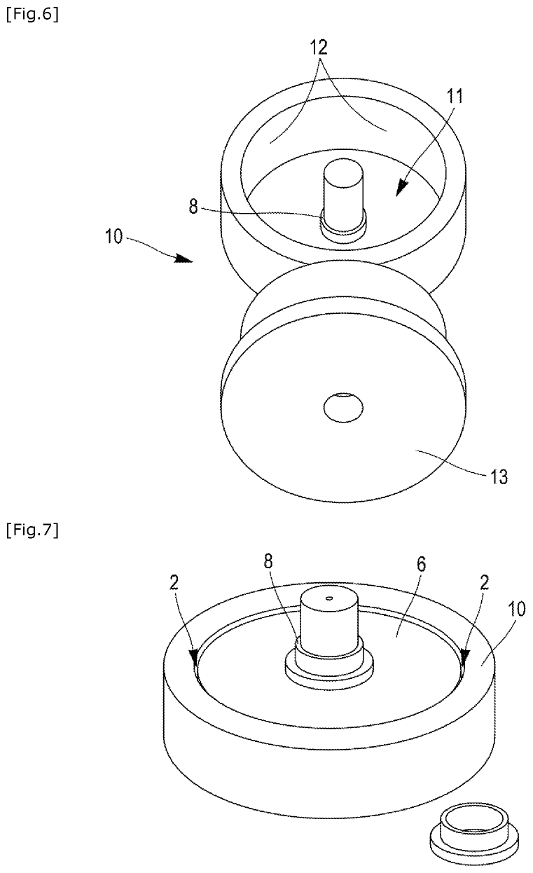

With reference to FIGS. 1 to 7, one embodiment of the invention is described.

A method for manufacturing an adsorbent coating 1 according to the invention is set forth therein. The method comprises the step of obtaining a homogeneous mixture comprising water, mesoporous particles whose grains have a diameter of less than 800 μm, a diameter of 100 μm according to the embodiment, and a reinforcement, cellulose (an unbranched linear polymer) according to the embodiment. According to the embodiment, silica gel was chosen as the mesoporous particle due to its low cost, ease of supply and the wide choice provided on the market. Other mesoporous particles, as described previously by way of non-limiting examples, could have been used.

The mixture is obtained by milling silica gel grains between 1 and 5 mm in size using a mill. The silica gel is sold by Humistore. The milled grains are sieved to retain only those grains with a diameter of less than 100 μm. 20 grammes of grains with a diameter of less than 100 μm are mixed with 5 grammes of cellulose to obtain a solid mixture. 39 grammes of water are added to the solid mixture and the mixture obtained is homogenised to obtain a homogeneous pasty mixture. The homogeneous mixture obtained according to the embodiment is pasty.

According to the embodiment, the method is applied to manufacturing an adsorber 4 and a heat exchanger 5 for use in an adsorption refrigeration machine. To this end, the piece to be coated 6 comprises a copper disc 61 with a diameter of 90 mm having an opening 7 in its centre. A brass ring 8 is introduced into the opening 7 in the copper disc 61. The ring 8 contains a shoulder 9. The ring 8 is introduced into the opening 7 until the shoulder 9 stops against one of the faces of the disc 61. The ring 8 is then fixed to the disc 61, for example by tin soldering. The assembly formed by the ring 8 and the disc 61 constitutes the piece to be coated 6.

The method then comprises the step of covering all or part of the piece to be coated 6 with a layer of homogeneous mixture. In particular, the piece to be coated 6 is at least partly lined with a homogeneous mixture. The slice and part of each of the two faces of the piece 6 are coated with a layer of homogeneous mixture. According to the embodiment, this step is carried out in a mould 10 containing a cavity 11 whose shape is adapted and complementary to that of the piece to be coated 6. A first layer of homogeneous mixture a few millimetres thick, typically two millimetres, is disposed at the bottom of the cavity 11. The piece to be coated 6 is deposited onto the first layer of homogeneous mixture. One of the faces of the piece to be coated 6 is in direct contact with the first layer of homogeneous mixture. Homogeneous mixture is deposited into the annular volume 2 of the cavity 11 extending between the circular wall 12 of the mould 10 and the slice of the disc 61 connecting the two parallel planar faces of the disc 61 of the piece to be coated 6. A second layer of homogeneous mixture is deposited onto the piece to be coated 6. The second layer of homogeneous mixture is in direct contact with the other face of the piece to be coated 6. The second layer of homogeneous mixture is also in contact with the homogeneous mixture filling the annular volume 2 of the cavity 11. The homogeneous mixture is therefore in contact with each of the two faces of disc 61 and with the slice of the disc 61. The homogeneous mixture lines the disc 61. The homogeneous mixture coats the piece to be coated 6 with the exception of the central opening 7. Depositing the homogeneous mixture in the annular volume 2 is performed prior to or concomitantly to depositing the second layer of homogeneous mixture. The lid 13 of the mould 10 directly bears against the second layer of homogeneous mixture and hermetically seals the cavity 11.

The method then comprises the step of compressing the layer of mixture onto the piece to be coated 6 under a pressure greater than 10 bar, under a pressure of 70 bar according to the embodiment. The pressure is applied to the lid 13 of the mould 10 for two minutes.

The lid 13 of the mould 10 is removed. The contents of mould 10 are left in the open air, at a temperature of about 20° C., for 4 hours. The contents of the mould 10, that is the piece to be coated 6 coated with the adsorbent coating 1 forms the adsorber 4, are mould released. The assembly comprising the piece to be coated 6 coated with the adsorbent coating 1 forms the adsorber 4. The adsorber 4 can be considered as a fin 4. The method does not require a hot drying step. Furthermore, this heating step used in the methods of the state of the art is generally at least one day.

The porous adsorbent coating 1 thus manufactured comprises 20 g of mesoporous particles whose grains have a diameter of less than 800 μm, the mesoporous particles consisting of 20 g of silica gel whose grains have a diameter of less than 100 μm according to the embodiment, 5 g of reinforcement, 5 g of cellulose according to the invention, and 5 g of adsorbed water.

The amount of adsorbed water in coating 1 is that of coating 1 under air in normal conditions. The total porosity of coating 1 is between 1 nm and 50 μm. The thickness of the coating 1 is between 0.1 mm and 20 mm, it is 5 mm according to the embodiment. The adsorbent coating 1 directly rests on the piece 6. The coating 1 lines the slice and each of the two faces of the disc 61. The coating 1 lines the piece to be coated 6 with the exception of the central opening 7. It has been observed that the coating 1 adheres to the piece to be coated 6. Furthermore, the fact that the coating 1 forms a continuous layer which lines the piece to be coated 6 contributes to stabilising the coating 1 on the piece 6 and to reinforcing the coating 1. The thermal conductivity of the porous adsorbent coating 1 is in the order of 0.12 W/m/K. Therefore, for a lower mass of silica gel, the porous coating 1 according to the invention makes it possible to obtain thermal conductivities at least equivalent to those of porous coatings of the state of the art.

The heat exchanger 5 according to the embodiment comprises a heat pipe 14. Each adsorber 4 of the exchanger 5 can be considered as a fin 4 of the exchanger 5. Several adsorbers 4 are mounted to the heat pipe 14 via their openings 7. The heat pipe 14 passes through the openings 7 of the adsorbers 4. The rings 8 of the adsorbers 4, which can be regarded as stops, are brought into contact with each other. The adsorbers 4 of exchanger 5 radially extend from the heat pipe 14. The adsorbers 4 of exchanger 5 are parallel to each other. It has been observed that the absence of adhesive between the coating 1 and the piece to be coated 6 reduces the resistance to transfer between the coolant and the adsorbers 4.

Several heat exchangers can be assembled within an adsorption machine, in particular a refrigeration machine. Preferably, the heat exchangers are assembled horizontally side by side.

Of course, the invention is not limited to the examples just described, and many adjustments can be made to these examples without departing from the scope of the invention.

Thus, in combinable alternatives to the previously described embodiments:
the homogeneous (pasty) mixture comprises:
between 50 and 98%, by mass, of water,
between 3 and 60%, by mass, of mesoporous particles,
between 2 and 40%, by mass, of a reinforcement, and/or
the porous adsorbent coating 1 thus manufactured comprises:
between 50 and 80%, by mass, of mesoporous particles whose grains have a diameter of less than 800 μm,
between 3 and 50%, by mass, of a reinforcement,
between 5 and 40%, by mass, of adsorbed water, and/or
the piece to be coated 6 has a thermal conductivity greater than 1 W/m/K, and/or
the reinforcement is a branched polymer, and/or
the step of covering all or part of the piece to be coated 6 is carried out by applying, depositing, pouring, injecting, spraying or vaporising the homogeneous mixture onto the piece to be coated 6.

Furthermore, the different characteristics, forms, alternatives and embodiments of the invention may be associated with each other according to various combinations insofar as they are not incompatible or exclusive of one another.

1. A method for manufacturing a porous adsorbent coating, said method comprising the steps of:
obtaining a homogeneous mixture comprising water, mesoporous particles whose grains have a diameter of less than 800 μm and a reinforcement;
covering all or part of a piece to be coated with a layer of homogeneous mixture,
compressing the layer of mixture onto the piece to be coated under a pressure greater than 10 bar;
the mixture comprises:
between 50 and 98%, by mass, of water;
between 3 and 60%, by mass, of mesoporous particles; and
between 2 and 40%, by mass, of a reinforcement.

2. The method according to claim 1, wherein the reinforcement is a linear polymer.

3. The method according to claim 1, wherein the reinforcement is a branched polymer.

4. The method according to claim 1, wherein the reinforcement is cellulose.

5. The method according to claim 1, wherein the mesoporous particles are silica gel.

6. The method according to claim 1, wherein the piece to be coated comprises two faces connected through a slice and wherein the step of covering all or part of the piece to be coated consists in lining the slice and all or part of each of the two faces of the piece.

7. The method according to claim 1, comprising, prior to, concomitantly or subsequently to the step of covering all or part of the piece to be coated, a step of arranging the piece to be coated in a mould.

8. The method according to claim 1, wherein the step of covering all or part of the piece to be coated is carried out by applying, depositing, casting, injecting, spraying or vaporising the homogeneous mixture onto the piece to be coated.

9. A porous adsorbent coating comprising:
between 50 and 80%, by mass, of mesoporous particles whose grains have a diameter of less than 800 μm;
between 3 and 50%, by mass, of a reinforcement; and
between 5 and 40%, by mass, of adsorbed water.

10. The coating according to claim 9, wherein the mesoporous particles are silica gel.

11. The coating according to claim 9, wherein the total porosity is between 1 nm and 100 μm.

12. The coating according to claim 9, having a thickness of between 0.1 mm and 20 mm.

13. A heat exchanger comprising the coating according to claim 9.

14. The heat exchanger according to claim 13, comprising at least one piece at least partly coated with the coating; the at least one piece has a thermal conductivity greater than 1 W/m/K.

15. The heat exchanger according to claim 14, wherein the coating directly rests on the at least one piece.

16. The heat exchanger according to claim 14, wherein the coating adheres to the at least one piece.

17. The heat exchanger according to claim 14, wherein the at least one piece comprises two faces and a slice connecting said two faces; the coating forms a continuous layer and lines said slice and at least one part of each of said two faces.

18. The heat exchanger according to claim 17, wherein the two faces are substantially planar surfaces connected through the slice; the slice forms an annular part of the at least one piece.

19. The heat exchanger according to claim 14, comprising a heat pipe to which is mounted the at least one piece at least partly coated with the coating.

20. The heat exchanger according to claim 19, wherein:
the at least one coated piece comprises an opening; and
the heat pipe is tubular and passes through the opening of the at least one piece.

21. An adsorption machine comprising at least one heat exchanger according to claim 13.
